(19) United States
(12) Patent Application Publication
(10) Pub. No.: US 2013/0286337 A1
(43) Pub. Date: Oct. 31, 2013

(54) LIQUID CRYSTAL DISPLAY DEVICE

(71) Applicants: Takao SATO, Mobara (JP); Yuji MAEDE, Mobara (JP); Toshiyuki MIMA, Chiba (JP); Toshiyuki KOSHITA, Chosei (JP)

(72) Inventors: Takao SATO, Mobara (JP); Yuji MAEDE, Mobara (JP); Toshiyuki MIMA, Chiba (JP); Toshiyuki KOSHITA, Chosei (JP)

(73) Assignees: PANASONIC LIQUID CRYSTAL DISPLAY CO., LTD., Himeji (JP); HITACHI DISPLAYS, LTD., Mobara (JP)

(21) Appl. No.: 13/928,955

(22) Filed: Jun. 27, 2013

Related U.S. Application Data
(62) Division of application No. 12/546,808, filed on Aug. 25, 2009.

(30) Foreign Application Priority Data
Aug. 26, 2008 (JP) 2008-217270

(51) Int. Cl. G02F 1/1337

(52) U.S. Cl. CPC G02F 1/1337
USPC 349/123

(57) ABSTRACT

The liquid crystal display device is provided with a plurality of spacers and a plurality of pedestals which include a first group of the spacers and the pedestals, the first group including at least a pair of one of the spacers and one of the pedestals opposing to each other, and a second group of the spacers and the pedestals, the second group including at least another pair of another one of the spacers and another one of the pedestals opposing to each other, in which the pair of the spacer and the pedestal which form the first group and the pair of the spacer and the pedestal which form the second group are disposed so that a center of the first surface and a center of the second surface are displaced in different directions.

### CROSS-REFERENCE TO RELATED APPLICATIONS

The present application is a divisional application of U.S. application Ser. No. 12/546,808, filed Aug. 25, 2009, and which application claims priority from Japanese application JP 2008-217270 filed on Aug. 26, 2008, the contents of which are hereby incorporated by reference into this application.

### BACKGROUND OF THE INVENTION

1. Field of the Invention

The present invention relates to a liquid crystal display device.

2. Description of the Related Art

A liquid crystal panel includes a pair of substrates. One of the substrates is provided with spacers formed thereon in order to secure a gap (space for sealing liquid crystal therein) between the substrates (see JP 2005-345819A, JP 2005-107494 A, and JP 2007-156221 A).

Alignment films are formed on opposing surfaces of the respective substrates, and the alignment films formed on the spacers formed on the substrate of one side of the substrates and the alignment film formed on the substrate of the other side of the substrates are brought into contact with each other. The contact may cause peeling off of the alignment films, and if the alignment films are peeled off and are caused to float within liquid crystal, there appear minute luminescent points (dots) due to reflection of light.

### SUMMARY OF THE INVENTION

It is a merit of the present invention to reduce a peeled area of an alignment film.

(1) A liquid crystal display device includes: a first substrate and a second substrate opposing to each other; a plurality of spacers formed on a surface of the first substrate, the surface opposing to the second substrate, the plurality of spacers each having a first surface on a top portion thereof; a first alignment film formed on and above the surface of the first substrate and on the plurality of spacers, the surface opposing to the second substrate; a plurality of pedestals formed on a surface of the second substrate, the surface opposing to the first substrate, the plurality of pedestals each having a second surface on a top portion thereof ; a second alignment film formed on and above the surface of the second substrate and on the plurality of pedestals, the surface opposing to the first substrate; and liquid crystal disposed between the first alignment film and the second alignment film, in which: the plurality of pedestals each are formed into an island-like shape; the first alignment film includes a first portion positioned on the first surface; the second alignment film includes a second portion positioned on the second surface; the second surface is smaller in area than the first surface; the first surface and the second surface are disposed so as to oppose to each other; the first portion and the second portion contact with each other; the plurality of spacers and the plurality of pedestals include a first group of the plurality of spacers and the plurality of pedestals, the first group including at least a first pair of one of the plurality of spacers and one of the plurality of pedestals opposing to each other, and a second group of the plurality of spacers and the plurality of pedestals, the second group including at least a second pair of another one of the plurality of spacers and another one of the plurality of pedestals opposing to each other; and the plurality of spacers and the plurality of pedestals which form the first group and the plurality of spacers and the plurality of pedestals which form the second group are disposed so that a center of the first surface and a center of the second surface are displaced in different directions. According to (1), the second surface of each of the pedestals is smaller in area than the first surface of each of the spacers, which reduces a contact area between the first alignment film and the second alignment film, to thereby prevent the first alignment film and the second alignment film from peeling off. Further, the spacer and the pedestal (the first surface and the second surface) in the first group and the spacer and the pedestal (the first surface and the second surface) in the second group are displaced in different directions. Accordingly, even if any one of the spacers falls off from the pedestal when the first substrate and the second substrate are displaced from each other, the rest of the spacers remain on the pedestals, to thereby secure a gap between the first substrate and the second substrate.

(2) In the liquid crystal display device of (1), the plurality of spacers and the plurality of pedestals may further include a third group of the plurality of spacers and the plurality of pedestals, the third group including at least a third pair of another one of the plurality of spacers and another one of the plurality of pedestals opposing to each other, and a fourth group of the plurality of spacers and the plurality of pedestals, the fourth group including at least a fourth pair of another one of the plurality of spacers and another one of the plurality of pedestals opposing to each other; and the plurality of spacers and the plurality of pedestals which form the third group and the plurality of spacers and the plurality of pedestals which form the fourth group may be disposed so that the center of the first surface and the center of the second surface are displaced in different directions.

(3) In the liquid crystal display device of (2), the plurality of spacers and the plurality of pedestals which form the first group and the plurality of spacers and the plurality of pedestals which form the second group may be disposed so that the center of the first surface and the center of the second surface are displaced in mutually opposite directions along a first straight line; the plurality of spacers and the plurality of pedestals which form the third group and the plurality of spacers and the plurality of pedestals which form the fourth group may be disposed so that the center of the first surface and the center of the second surface are displaced in mutually opposite directions along a second straight line; and the first straight line and the second straight line may intersect with each other at an angle of from 75° to 90°.

(4) A liquid crystal display device includes: a first substrate and a second substrate opposing to each other; a spacer formed on and above a surface of the first substrate, the surface opposing to the second substrate; a first alignment film formed on the surface of the first substrate and on the spacer, the surface opposing to the second substrate; a pedestal formed on a surface of the second substrate, the surface opposing to the first substrate; a second alignment film formed on and above the surface of the second substrate and on the pedestal, the surface opposing to the first substrate; and liquid crystal disposed between the first alignment film and the second alignment film, in which: the pedestal is formed into an island-like shape and includes at least one thin part and a plurality of thick parts; the spacer opposes to the at least one thin part and at least two of the plurality of thick parts; the second alignment film includes a portion which contacts with a portion of the first alignment film, the portion of the second alignment film being provided on each of the plurality of thick parts, the portion of the first alignment film being provided on the spacer; and the second alignment film includes another portion which avoids contact with the portion of the first alignment film, the another portion of the second alignment film being provided on the at least one thin part, the portion of the first alignment film being provided on the spacer. According to (4), the first alignment film and the second alignment film contact with each other between only a part (thick part) of the pedestal and the spacer, which reduces a contact area therebetween, to thereby prevent the first alignment film or the second alignment film from peeling off. Further, due to the plurality of thick parts formed, even if a spacer falls off from any one of the thick parts, the spacer is supported by the other thick parts, to thereby secure a gap between the first substrate and the second substrate.

(5) In the liquid crystal display device of (4), the pedestal may include a plurality of first layers and at least one second layer which includes portions overlapping with the plurality of first layers; the at least one thin part may include portions in the plurality of first layers except for portions overlapping with the at least one second layer, and portions in the at least one second layer except for the portions overlapping with the plurality of first layers; and the plurality of thick parts each may include the portions of the plurality of first layers and the portions of the at least one second layer, the portions overlapping with one another.

(6) In the liquid crystal display device of (5), the at least one second layer maybe formed into a band-like shape; and the plurality of first layers each may be formed into a band-like shape and extend in a direction intersecting with the at least one second layer.

(7) In the liquid crystal display device of (6), the pedestal may include a plurality of the second layers, and the plurality of first layers and the plurality of the second layers may be disposed in a grid pattern.

(8) A liquid crystal display device includes: a first substrate and a second substrate opposing to each other; a plurality of spacers formed on a surface of the first substrate, the surface opposing to the second substrate, the plurality of spacers each having a first surface on a top portion thereof; a first alignment film formed on and above the surface of the first substrate and on the plurality of spacers, the surface opposing to the second substrate; a plurality of pedestals formed on a surface of the second substrate, the surface opposing to the first substrate, the plurality of pedestals each having a second surface on a top portion thereof; a second alignment film formed on and above the surface of the second substrate and on the plurality of pedestals, the surface opposing to the first substrate; liquid crystal disposed between the first alignment film and the second alignment film; and a seal for fixing an edge part of the first substrate and an edge part of the second substrate to each other, in which: the plurality of pedestals each are formed into an island-like shape; the second surface is smaller in area than the first surface; the first surface and the second surface oppose to each other; the first alignment film includes a first portion positioned on the first surface; the second alignment film includes a second portion positioned on the second surface; the first portion and the second portion contact with each other; the plurality of spacers and the plurality of pedestals include a first group of the plurality of spacers and the plurality of pedestals, the first group including at least a first pair of one of the plurality of spacers and one of the plurality of pedestals opposing to each other, and a second group of the plurality of spacers and the plurality of pedestals, the second group including at least a second pair of another one of the plurality of spacers and another one of the plurality of pedestals opposing to each other; the plurality of spacers and the plurality of pedestals which form the second group are disposed farther away, than the plurality of spacers and the plurality of pedestals which form the first group, from the edge part of the first substrate and from the edge part of the second substrate; and the first surface of each of the plurality of spacers forming the second group is larger in area than the first surface of each of the plurality of spacers forming the first group. According to (8), the second surface of each of the pedestals is smaller in area than the first surface of each of the spacers, which reduces a contact area between the first alignment film and the second alignment film, to thereby prevent the first alignment film or the second alignment film from peeling off. Further, the first substrate and the second substrate are fixed to each other at the edge parts thereof, and hence the displacement therebetween is smaller in the edge parts and larger in the center, while, in the third aspect of the present invention, the first surface of each of the spacers in the second group which is provided away from the edge parts is larger in area than the first surface of each of the spacers in the first group which is provided closer to the edge parts, which makes a spacer less likely to fall off from a pedestal.

(9) In the liquid crystal display device of (8), the second surface of each of the plurality of pedestals forming the second group may be larger in area in area than the second surface of each of the plurality of pedestals forming the first group.

### BRIEF DESCRIPTION OF THE DRAWINGS

In the accompanying drawings:

FIG. 1 is an exploded perspective view illustrating a liquid crystal display device according to a first embodiment of the present invention;

FIG. 2 is a cross-sectional diagram illustrating a part of the liquid crystal display device;

FIG. 3 is a plan view illustrating relative positions of spacers and pedestals;

FIG. 4A is a plan view illustrating a spacer and a pedestal of a liquid crystal display device according to a second embodiment of the present invention;

FIG. 4B is a cross-sectional diagram of the spacer and the pedestal illustrated in FIG. 4A, which is taken along the line IVB-IVB of FIG. 4A;

FIG. 5 is a diagram illustrating a state where the spacer is displaced;

FIG. 6 is a plan view illustrating a spacer and a pedestal of a liquid crystal display device according to a modification example of the second embodiment of the present invention;

FIG. 7 is a plan view illustrating a liquid crystal display device according to a third embodiment of the present invention; and

FIG. 8 is a partially enlarged plan view illustrating the liquid crystal display device according to the third embodiment of the present invention.

### DETAILED DESCRIPTION OF THE INVENTION

Hereinafter, embodiments of the present invention are described with reference to the accompanying drawings.

### First Embodiment

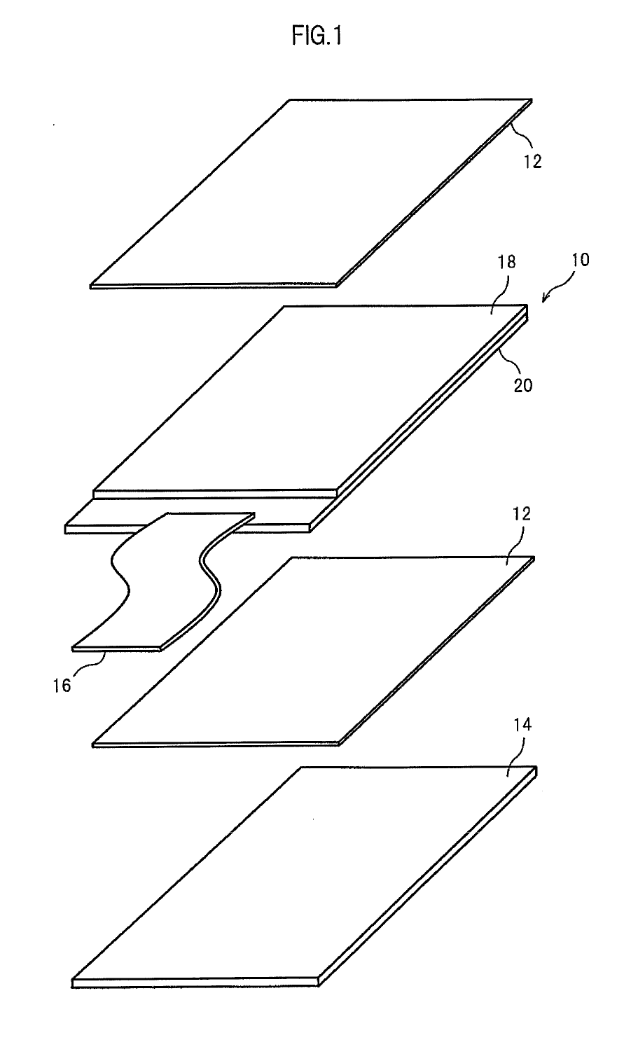

FIG. 1 is an exploded perspective view illustrating a liquid crystal display device according to a first embodiment of the present invention. The liquid crystal display device includes a liquid crystal panel 10. Polarizing plates 12 each are disposed on both sides of the liquid crystal panel 10. The liquid crystal display device includes a backlight 14. One of the polarizing plates 12 is interposed between the liquid crystal panel 10 and the backlight 14. The liquid crystal panel 10 is provided with a flexible printed wiring board 16 mounted thereon.

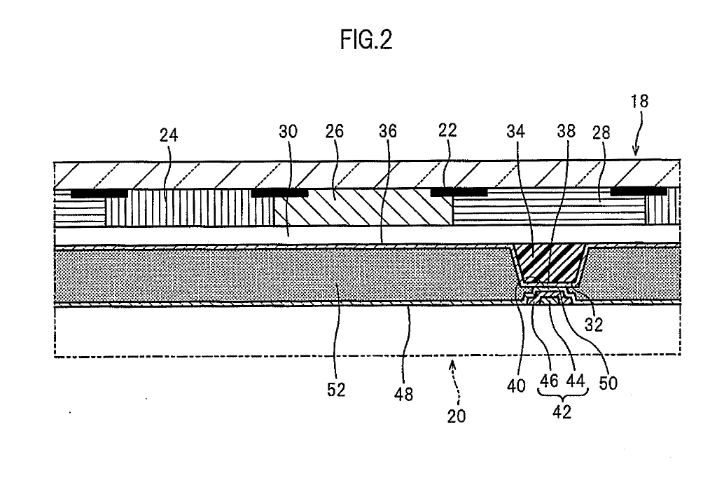

FIG. 2 is a cross-sectional diagram illustrating a part of the liquid crystal display device. The liquid crystal display device includes a first substrate 18 and a second substrate 20 opposing to each other. The first substrate 18 and the second substrate 20 each form a part of the liquid crystal panel 10.

One of the first substrate 18 and the second substrate 20 (first substrate 18 of FIG. 2) includes a color filter substrate which includes a black matrix 22 and colored layers 24, 26, and 28 of a plurality of colors (for example, three colors of red (R), green (G), and blue (B)). One pixel includes a plurality of sub pixels including the colored layers 24, 26, and 28 of the plurality of colors . The colored layers 24, 26, and 28 are covered with an overcoat layer 30.

The other one of the first substrate 18 and the second substrate 20 (second substrate 20 of FIG. 2) includes a thin film transistor (TFT) substrate (or an array substrate) which includes a TFT (not shown) and a pixel electrode (not shown).

A plurality of spacers (columnar spacers) 34 are formed on a surface of the first substrate 18, the surface opposing to the second substrate 20. The plurality of spacers 34 each have a first surface 32 on a top portion thereof. The spacers 34 each are in a truncated cone shape according to this embodiment. Alternatively, the spacers 34 each may be in a truncated pyramidal shape or in a columnar shape (such as a circular column or a rectangular column). The plurality of spacers 34 may be disposed so as to oppose to each of the colored layers 24, 26, and 28 of the plurality of colors, respectively. However, in the example of FIG. 2, the spacer 34 is provided so as to oppose only to each of the colored layers 28 of blue. Further, the plurality of spacers 34 are disposed so as to oppose to all the colored layers 28 of blue, but the plurality of spacers 34 may also be disposed so that some of the colored layers 28 are skipped. The spacers 34 may be formed of a resin, and may be formed in a process employing photolithography.

A first alignment film 36 is formed on a surface of the first substrate 18, the surface opposing to the second substrate 20 (for example, a surface of the overcoat layer 30), and on the plurality of spacers 34. The first alignment film 36 includes a first portion 38 positioned on the first surface 32 of the spacer 34.

On a surface of the second substrate 20, the surface opposing to the first substrate 18, a plurality of pedestals 42 are formed. The plurality of pedestals 42 each have a second surface 40 on a top portion thereof . The pedestals 42 each are formed of a plurality of layers. For example, a second layer 46 in a band-like shape may be formed on a first layer 44 in a band-like shape, so that the first layer 44 and the second layer 46 intersect with each other (for example, at right angles), to thereby form the pedestal 42. With this configuration, even when the first layer 44 and the second layer 46 are displaced from each other in some degree, the overlapping portions between the first layer 44 and the second layer 46 remain the same in area. For example, the first layer 44 may be formed of silicon and the second layer 46 may be formed of aluminum, by chemical vapor deposition (CVD).

A second alignment film 48 is formed on a surface of the second substrate 20, the surface opposing to the first substrate 18, and on the plurality of pedestals 42. The second alignment film 48 includes a second portion 50 positioned on the second surface 40 of the pedestal 42. The second surface 40 of the pedestal 42 is smaller in area than the first surface 32 of the spacer 34. The first surface 32 of the spacer 34 and the second surface 40 of the pedestal 42 are disposed so as to oppose to each other. The first portion 38 of the first alignment film 36 and the second portion 50 of the second alignment film 48 contact with each other. The spacer 34 is compressed between the first substrate 18 and the second substrate 20 in a direction in which the first substrate 18 and the second substrate 20 come close to each other. With this configuration, the contact state is maintained between the first portion 38 of the first alignment film 36 and the second portion 50 of the second alignment film 48. Then, liquid crystal 52 is sealed in between the first alignment film 36 and the second alignment film 48.

According to this embodiment, the second surface 40 of the pedestal 42 is smaller in area than the first surface 32 of the spacer 34, and therefore the contact area between the first alignment film 36 and the second alignment film 48 may be reduced, to thereby reduce the peeled area in the first alignment film 36 or in the second alignment film 48.

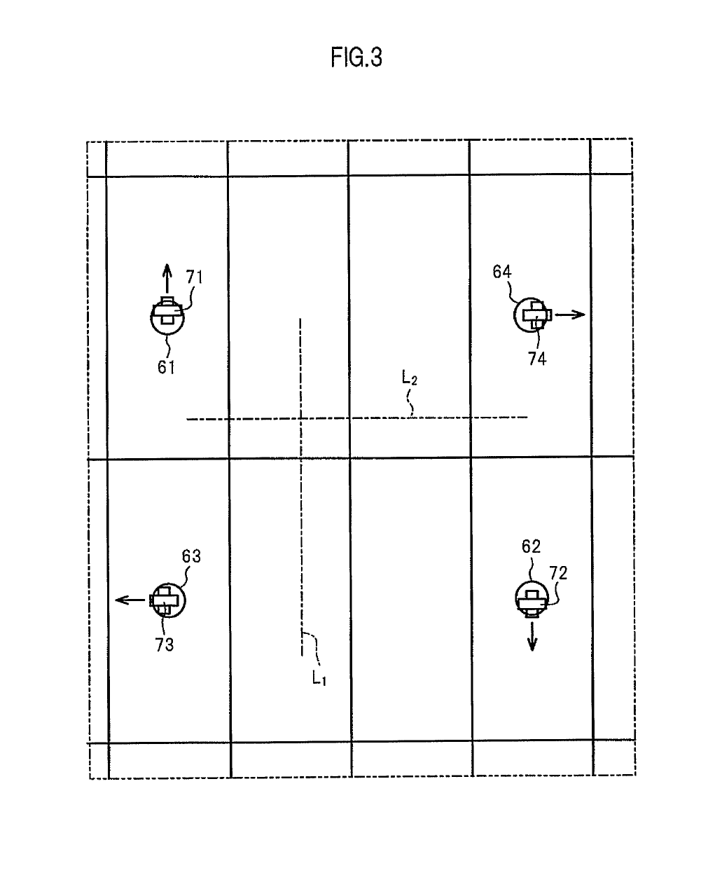

FIG. 3 is a plan view illustrating relative positions of the spacers and the pedestals. The plurality of spacers 34 and the plurality of pedestals 42 include a spacer 61 and a pedestal 71 as a first group which includes at least a pair of a spacer 34 and a pedestal 42 opposing to each other. The plurality of spacers 34 and the plurality of pedestals 42 also include a spacer 62 and a pedestal 72 as a second group which includes at least another pair of another spacer 34 and another pedestal 42 opposing to each other. The spacer 61 and the pedestal 71 forming the first group and the spacer 62 and the pedestal 72 forming the second group are disposed so that the center of the first surface 32 and the center of the second surface 40 are displaced from each other in different directions (for example, in mutually opposite directions along a first straight line L₁).

According to this embodiment, the spacer 34 and the pedestal 42 (the first surface 32 and the second surface 40) of the first group and the spacer 34 and the pedestal 42 (the first surface 32 and the second surface 40) of the second group are displaced in different directions. Accordingly, even when the first substrate 18 and the second substrate 20 are displaced and any one of the spacers 34 is displaced to fall off from the pedestal 42, the rest of the spacers 34 remain on the pedestals 42, to thereby secure a gap between the first substrate 18 and the second substrate 20.

The plurality of spacers 34 and the plurality of pedestals 42 include a spacer 63 and a pedestal 73 as a third group which includes at least further another pair of further another spacer 34 and further another pedestal 42 opposing to each other. The plurality of spacers 34 and the plurality of pedestals 42 also include a spacer 64 and a pedestal 74 as a fourth group which includes at least still further another pair of still further another spacer 34 and still further another pedestal 42 opposing to each other. The spacer 63 and the pedestal 73 forming the third group and the spacer 64 and the pedestal 74 forming the fourth group are disposed so that the center of the first surface 32 and the center of the second surface 40 are displaced from each other in different directions (for example, in mutually opposite directions along a second straight line L₂ which intersects with the first straight line L₁ at an angle of from 75° to 90° (for example, at a right angle)).

According to this embodiment, the spacers 34 and the pedestals 42 (the first surfaces 32 and the second surfaces 40) of the first to fourth groups are displaced in four different directions. Accordingly, no matter in which direction the first substrate 18 and the second substrate 20 are displaced, at least one of the spacers 34 remains on the pedestal 42, to thereby secure the gap between the first substrate 18 and the second substrate 20.

### Second Embodiment

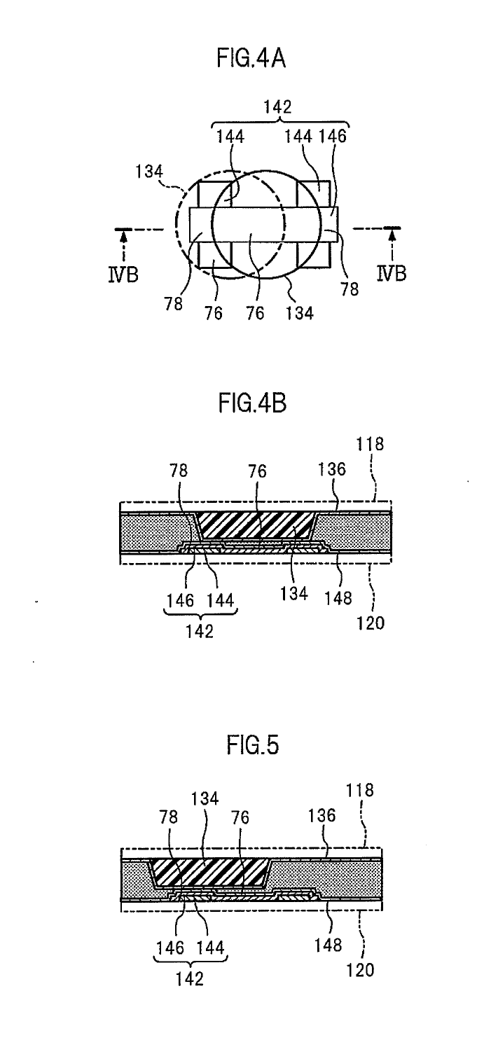

FIG. 4A is a plan view illustrating a spacer and a pedestal of a liquid crystal display device according to a second embodiment of the present invention, and FIG. 4B is a cross-sectional diagram of the spacer and the pedestal illustrated in FIG. 4A, which is taken along the line IVB-IVB of FIG. 4A. According to this embodiment, a pedestal 142 is different in shape from the pedestal 42 of the first embodiment.

The pedestal 142 includes at least one thin part 76 and a plurality of thick parts 78. The pedestal 142 includes a plurality of first layers 144 and at least one second layer 146 which overlaps in part with the plurality of first layers 144. The first layers 144 may be formed on the second layer 146, or vice versa. In this embodiment, the first layers 144 are formed on a second substrate 120, and the second layer 146 is formed on the first layers 144 and on and above the second substrate 120.

The thin part 76 includes portions in the first layers 144 except for portions overlapping with the second layer 146 and portions in the second layer 146 except for portions overlapping with the first layer 144. The thick parts 78 include portions at which each of the first layers 144 and the second layer 146 overlap with each another. The first layer 144 and the second layer 146 each are formed into a band-like shape and extend in directions intersecting with each other.

A spacer 134 formed on a first substrate 118 opposes to at least one thin part 76 and to two or more of the thick parts 78. A second alignment film 148 includes a portion being provided on one of the thick parts 78, the portion contacting with a portion of a first alignment film 136, the portion being provided on the spacer 134. The second alignment film 148 also includes another portion provided on the thin part 76, which does not contact with another portion of the first alignment film 136, the another portion being provided on the spacer 134.

According to this embodiment, the first alignment film 136 contacts with the second alignment film 148 between the spacer 134 and only in part (thick part 78) of the pedestal 142, which reduces the contact area between the first alignment film 136 and the second alignment film 148, to thereby reduce the peeled area in the first alignment film 136 or in the second alignment film 148.

Further, due to the plurality of thick parts 78 formed, even when the spacer 134 falls off from any one of the thick parts 78 (see the spacer 134 illustrated by the dashed-two dotted line of FIG. 4A), the spacer 134 is supported by the other thick parts 78, to thereby secure a gap between the first substrate 118 and the second substrate 120. FIG. 5 is a diagram illustrating a state where the spacer 134 is displaced.

Any other configurations and a manufacturing method therefor according to this embodiment are similar to those described in the first embodiment.

### Modification Example

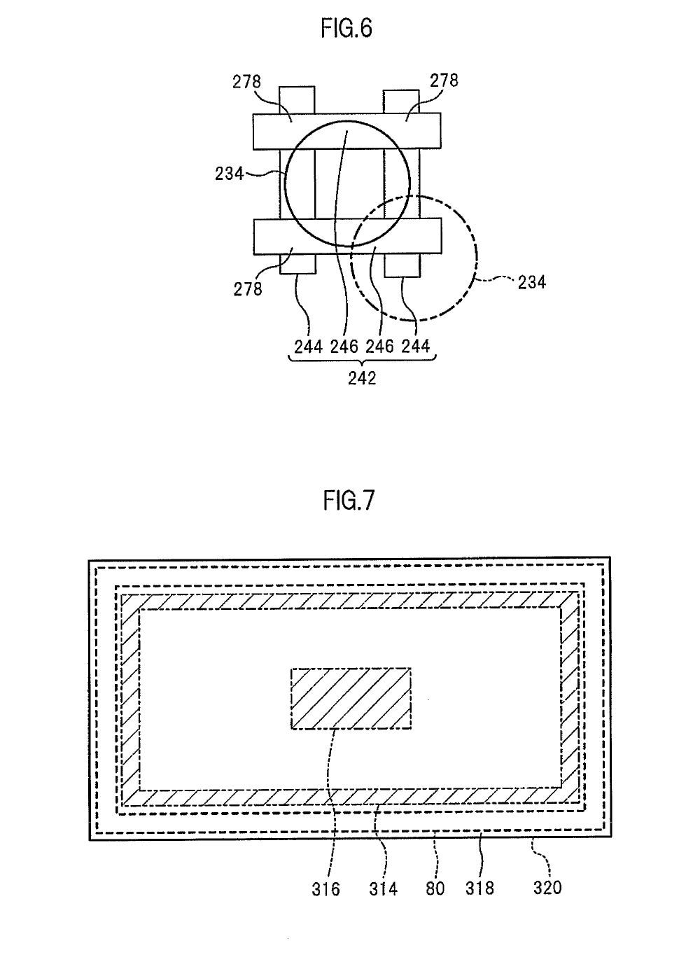

FIG. 6 is a plan view illustrating a spacer and a pedestal of a liquid crystal display device according to a modification example of the second embodiment of the present invention. The modification example is different from the second embodiment in that a pedestal 242 is different from the pedestal 142 in shape.

The pedestal 242 includes a plurality of second layers 246. A plurality of first layers 244 and the plurality of second layers 246 are disposed in a grid pattern. With this configuration, the number of thick parts 278 to be formed may further be increased, and hence a spacer 234 does not fall off from the pedestal 242 even when the spacer 234 is greatly displaced as illustrated by the dashed-two dotted line. Any other configurations are similar to those described in the second embodiment.

### Third Embodiment

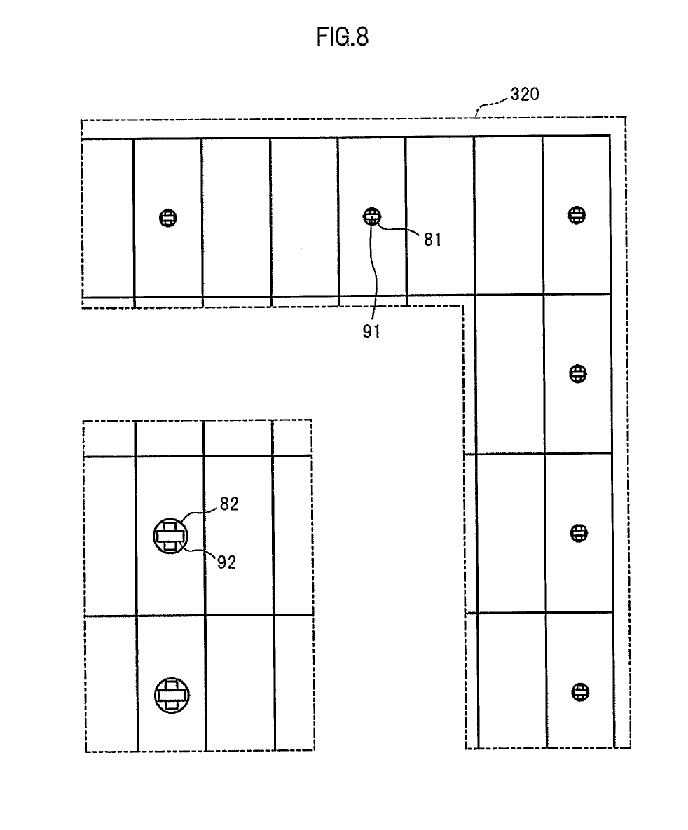

FIG. 7 is a plan view illustrating a liquid crystal display device according to a third embodiment of the present invention. FIG. 8 is a partially enlarged plan view illustrating the liquid crystal display device according to the third embodiment of the present invention.

An edge part of a first substrate 318 and an edge part of a second substrate 320 are fixed to each other by a seal 80. The same applies to the first embodiment and the second embodiment described above.

The liquid crystal display device includes a plurality of spacers and a plurality of pedestals. The plurality of spacers and the plurality of pedestals include a spacer 81 and a pedestal 91 as a first group which includes at least a pair of a spacer and a pedestal opposing to each other, and a spacer 82 and a pedestal 92 as a second group which includes at least another pair of a spacer and a pedestal opposing to each other. The spacer 81 and the pedestal 91 of the first group are formed in a region 314. The spacer 82 and the pedestal 92 of the second group are formed in a region 316. The region 316 lies farther away (closer to the center), than the region 314, from the edge part of the first substrate 318 and from the edge part of the second substrate 320.

As illustrated in FIG. 8, a first surface of the spacer 82 in the second group is larger in area than a first surface of the spacer 81 in the first group. Further, a second surface of the pedestal 92 in the second group is larger in area than a second surface of the pedestal 91 in the first group. The pedestal 92 formed into an island-like shape is smaller in area than the spacer 82, which reduces the peeled area in alignment films. The pedestal 91 formed into an island-like shape is smaller in area than the spacer 81, which reduces the peeled area in the alignment films.

According to this embodiment, the first substrate 318 and the second substrate 320 are fixed to each other at edge parts thereof, and the displacement therebetween is smaller in the edge parts and larger in the center. According to this embodiment, the first surface of the spacer 82 in the second group, which lies farther away from the edge parts, is larger in area than the first surface of the spacer 81 in the first group, which lies closer to the edge parts, which makes the spacer 82 less likely to fall off from the pedestal 92. Any other configurations and a manufacturing method therefor according to this embodiment are similar to those described in the first embodiment.

The present invention is not limited to the above-mentioned embodiments, and may be subjected to various modifications. For example, the configurations described in the embodiments may be replaced by a substantially similar configuration, a configuration capable of attaining similar operations and effects, or a configuration capable of attaining a similar object. Further, two or more of the first embodiment, the second embodiment, and the third embodiment maybe employed in combination for implementing the present invention.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a first substrate and a second substrate opposing to each other;
a spacer formed on a surface of the first substrate, the surface opposing to the second substrate;
a first alignment film formed on and above the surface of the first substrate and on the spacer, the surface opposing to the second substrate;
a pedestal formed on a surface of the second substrate, the surface opposing to the first substrate;
a second alignment film formed on and above the surface of the second substrate and on the pedestal, the surface opposing to the first substrate; and
liquid crystal disposed between the first alignment film and the second alignment film, wherein:
the pedestal is formed into an island-like shape and includes at least one thin part and a plurality of thick parts;
the spacer opposes to the at least one thin part and at least two of the plurality of thick parts;
the second alignment film includes a portion which contacts with a portion of the first alignment film, the portion of the second alignment film being provided on each of the plurality of thick parts, the portion of the first alignment film being provided on the spacer; and
the second alignment film includes another portion which is located to contact with the portion of the first alignment film, the another portion of the second alignment film being provided on the at least one thin part, the portion of the first alignment film being provided on the spacer.

2. The liquid crystal display device according to claim 1, wherein:
the pedestal includes a plurality of first layers and at least one second layer which includes portions overlapping with the plurality of first layers;
the at least one thin part includes portions in the plurality of first layers except for portions overlapping with the at least one second layer, and portions in the at least one second layer except for the portions overlapping with the plurality of first layers; and
the plurality of thick parts each include the portions of the plurality of first layers and the portions of the at least one second layer, the portions overlapping with one another.

3. The liquid crystal display device according to claim 2, wherein:
the at least one second layer is formed into a band-like shape; and
the plurality of first layers each are formed into a band-like shape and extend in a direction intersecting with the at least one second layer.

4. The liquid crystal display device according to claim 3, wherein:
the pedestal includes a plurality of the second layers; and
the plurality of first layers and the plurality of the second layers are disposed in a grid pattern.
